(19) United States
(12) Patent Application Publication
(10) Pub. No.: US 2012/0306303 A1
(43) Pub. Date: Dec. 6, 2012

(54) SPINDLE MOTOR

(75) Inventors: Young Tae KIM, Seoul (KR); Sang Jin PARK, Gyunggi-do (KR); Won Ki PARK, Gyunggi-do (KR); Ik Sun LEE, Seoul (KR)

(73) Assignee: SAMSUNG ELECTRO-MECHANICS CO., LTD., Gyunggi-do (KR)

(21) Appl. No.: 13/427,799

(22) Filed: Mar. 22, 2012

(30) Foreign Application Priority Data
Jun. 1, 2011 (KR) 10-2011-0052813

(51) Int. Cl. H02K 7/08

(52) U.S. Cl. 310/90

(57) ABSTRACT

Disclosed herein is a spindle motor including a rotating part including a rotating shaft, a hub, and a magnet and a fixing part including a sleeve supporting the rotating shaft and an armature opposite to the magnet, wherein a working fluid is injected between the rotating shaft and the sleeve so as to form a fluid dynamic bearing part, and the sleeve is as a sintered sleeve by sintering and a top and a bottom of an inner peripheral surface of the sleeve is protruded toward the rotating shaft, whereby the spindle motor improving dynamic pumping capability and extending a span of a radial bearing part to a top end and a bottom end of the sleeve as compared with the spindle motor according to the prior art can be provided.

### CROSS REFERENCE TO RELATED APPLICATION

This application claims the benefit of Korean Patent Application No. 10-2011-0052813, filed on Jun. 1, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor used as a driving device of a recording disk, such as a hard disk, or the like, uses, for example, a lubricant fluid, such as oil, or the like, stored in a gap between a rotating shaft and a sleeve at the time of a rotation of a motor and a fluid dynamic bearing using a dynamic pressure generated thereby, or the like.

In more detail, since the spindle motor including the fluid dynamic bearing that maintains shaft rigidity of the rotating shaft using only movable pressure of lubricant based on a centrifugal force is operated, metal friction does not occur resulting in increased stability as a rotational speed is increased such that the generation of noise and vibration is reduced and a rotating object can be more readily rotated at a high speed than a motor having a ball bearing. As a result, the spindle motor is mainly applied to a high end optical disk device, a magnetic disk device, or the like.

The fluid dynamic bearing included in the spindle motor having these features includes a rotating shaft that is a rotating center and a sleeve assembled in the rotating shaft to form a sliding surface. Any one thereof is provided with dynamic grooves in a herringbone shape or a spiral shape. Further, the fluid dynamic bearing has a bearing structure supporting a rotating member, that is, a rotor, which fills a lubricant in a gap finely formed on the sliding surface between the rotating shaft and the sleeve, such that the rotating shaft does not contact the sleeve due to the dynamic pressure generated from the grooves of the sliding surface and a friction load is reduced at the time of rotation driving.

In addition, in the fluid dynamic bearing of the spindle motor, the machining of the sleeve having the grooves and the shape machining of the dynamic generation grooves may be made in various shapes by a manufacturing method such as cutting, electrolytic machining, sintering bearing, or the like. Further, in the case of the sleeve forming the dynamic bearing, cylindricity thereof is generally managed to be 1 μm or less, while in the case of a sintered sleeve, cylindricity thereof is managed to be larger than the cylindricity of the above sleeve. As a result, the dynamic characteristics may be degraded.

Further, the sintered sleeve of the spindle motor according to the prior art is made using a sintered body of Cu—Fe, Fe, or SUS. The cylindricity of the sintered body has a straight shape and the pumping capability of a radial dynamic bearing may be limited.

### SUMMARY OF THE INVENTION

The present invention has been made in an effort to provide a spindle motor capable of improving dynamic pumping capability and extending a span of a radial bearing part to a top end and a bottom end of the sleeve as compared with the spindle motor according to the prior art by manufacturing the sleeve as a sintered sleeve and forming a top and a bottom of an inner peripheral surface of the sleeve as a curved part protruded toward a rotating shaft.

According to a preferred embodiment of the present invention, there is provided a spindle motor including: a rotating part including a rotating shaft, a hub, and a magnet; and a fixing part including a sleeve supporting the rotating shaft and an armature opposite to the magnet, wherein a working fluid is injected between the rotating shaft and the sleeve so as to form a fluid dynamic bearing part, and the sleeve is a sintered sleeve by sintering and a top and a bottom of an inner peripheral surface of the sleeve is protruded toward the rotating shaft.

The top and the bottom of the inner peripheral surface of the sleeve may be formed as a curved part protruded toward the rotating shaft.

An inner diameter of the sleeve may have the same size as a top end and a bottom end thereof about a direction of the rotating shaft and the size of the top end and the bottom end may be smaller than that of a central portion thereof.

The inner diameter of the central portion of the sleeve may be larger by 0.1 to 1.0 μm than the inner diameter of the top end and the bottom end of the sleeve.

The inner peripheral surface of the sleeve and an outer peripheral surface of the rotating shaft opposite thereto may be selectively provided with radial dynamic generation grooves and a radial dynamic bearing part is formed by the radial dynamic generation grooves.

The top of the sleeve opposite to the hub may be provided with thrust dynamic generation grooves and a thrust bearing part is formed by the thrust dynamic generation grooves.

The fixing part may further include: a base having the sleeve fixed to an inner peripheral portion thereof by press-fit or an adhesive and having the armature fixed to an outer peripheral portion thereof so as to be opposite to the magnet by press-fit and an adhesive; and a cover coupled with a bottom end of the base to support the rotating shaft and seal the fluid.

### BRIEF DESCRIPTION OF THE DRAWINGS

FIG. 1 is a cross-sectional view schematically showing a spindle motor according to a preferred embodiment of the present invention;

FIG. 2 is a cross-sectional view schematically showing a sleeve in the spindle motor shown in FIG. 1; and

FIGS. 3 and 4 are cross-sectional views schematically comparing a shape and dynamic strength between a sleeve of a spindle motor according to the present invention and a sleeve of a spindle motor according to the prior art, wherein FIG. 3 shows a sleeve of a spindle motor according to the present invention and FIG. 4 shows a sleeve of a spindle motor according to the prior alt.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, a spindle motor according to preferred embodiments of the present invention will be described in detail with reference to the accompanying drawings.

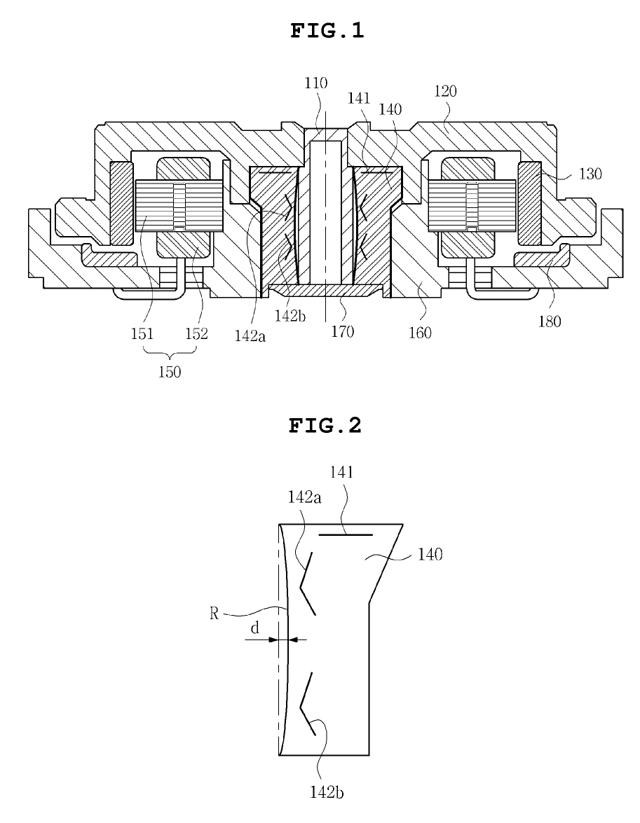

FIG. 1 is a cross-sectional view schematically showing a spindle motor according to a preferred embodiment of the present invention. As shown in FIG. 1, a spindle motor 100 includes a rotating part that includes a rotating shaft 110, a hub 120, and a magnet 130 and a fixing part that includes a sleeve 140, an armature 150, a base 160, a cover 170, and a suction magnet 180, wherein a gap between the rotating shaft 110 and the sleeve 140 and a gap between the sleeve 140 and the hub 120 is provided with a fluid dynamic bearing part by injecting a working fluid thereinto.

In more detail, an outer peripheral surface of a top end of the rotating shaft 110 is provided with the hub 120 and is rotatably supported to the sleeve 140.

Further, as described above, the hub 120 is fixedly connected with the top end of the rotating shaft 110 and rotates together with the rotating shaft 110.

In more detail, the hub 120 has a cylindrical part fixed to the top end of the rotating shaft 110, a disk part extending to a radial outer side from the cylindrical part, and a side wall part extending axially downward from a radial outer end of the disk.

In addition, an inner peripheral surface of the side wall part of the hub 120 is provided with the annular ring shaped magnet 130 so as to be opposite to the armature 150.

The sleeve 140 has a cylindrical shape so as to rotatably support the rotating shaft 110 and is a sintered sleeve 140 formed by sintering. To this end, the sintered sleeve 140 is formed by sintering a Cu—Fe based alloy powder or an SUS based powder.

Further, the top of the sleeve 140 opposite to the hub 120 is provided with a thrust dynamic generation groove 141 so as to form a thrust dynamic bearing part.

In addition, the inner peripheral surface of the sleeve 140 to be opposite to the rotating shaft 110 is provided with radial dynamic generation grooves 142a and 142b so as to form the radial dynamic bearing part by the working fluid.

The radial dynamic generation grooves 142a and 142b may be each formed axially above and under the rotating shaft 110 to be formed as the upper radial dynamic generation groove 142a and the lower radial dynamic generation groove 142b. Further, the upper and lower radial dynamic generation grooves 142a and 142b may be formed as one of a herringbone shape, a spiral shape, or a helix shape. Further, if the dynamic generation grooves have a shape generating the radial dynamic pressure, the shape and number thereof are not limited. Meanwhile, the radial dynamic generation grooves for forming the radial dynamic bearing part may be also formed at the rotating shaft 110 opposite to the sleeve 140.

In addition, according to the preferred embodiment of the present invention, when considering the shape of the sleeve 140, the inner peripheral surface of the sleeve 140 of the spindle motor 100 axially above and under the rotating shaft is protruded toward the rotating shaft 110. That is, the top end and the bottom end thereof may be formed in a tapered shape.

In addition, as shown in FIG. 2 in more detail, the top and the bottom of the inner peripheral surface thereof may be formed as a curved part protruded toward the rotating shaft. That is, an inner diameter of the sleeve 140 is set to have the same size as an inner diameter of the top end and the bottom end thereof about the direction of the rotating shaft and the size of the inner diameter of the top end and the bottom end of the sleeve is set to be smaller than that of the central portion thereof.

In addition, the inner diameter of the central portion of the sleeve 140 may be formed to be larger by 0.1 to 1.0 μm than that of the top end and the bottom end of the sleeve 140. That is, the difference between the inner diameters of the sleeve shown by “d” in FIG. 2 may be formed at 0.1 to 1.0 μm. This is to improve the rigidity capability of a journal part forming the dynamic bearing part while maintaining mechanical stability of the sleeve and to widen a span to the top end and the bottom end of the sleeve while increasing the cylindricity.

Further, an inner peripheral portion of the base 160 is fixed with the sleeve 140 by press-fit, an adhesive, or the like and an outer peripheral portion thereof is fixed with the armature 150 including a core 151 and a coil 152 to be opposite to the magnet 130 by press-fit, an adhesive, or the like

Further, the cover 170 is coupled with the bottom end of the sleeve 140 and supports the rotating shaft 110 and seals the fluid injected so as to form the dynamic bearing part.

Further, the suction magnet 180 is opposite to the hub 120 and the magnet 130 and is mounted on the base 160 to prevent the rotating part from rising.

Hereinafter, the shapes, functions, and effects of the sleeve according to the preferred embodiment of the present invention will be described in more detail by comparing the sleeve of the spindle motor according to the prior art with the sleeve of the spindle motor according to the present invention.

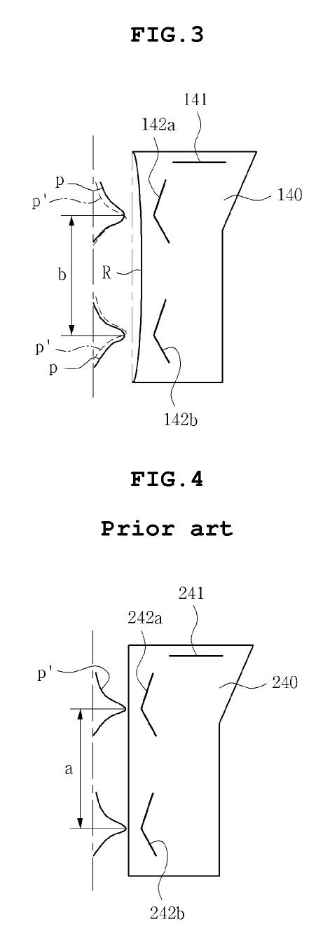

FIGS. 4 and 3 are cross-sectional views schematically comparing a shape and dynamic strength between a sleeve of a spindle motor according to the present invention and a sleeve of a spindle motor according to the prior art, wherein FIG. 4 shows a sleeve of a spindle motor according to the prior art and FIG. 3 shows a sleeve of a spindle motor according to the present invention.

As shown in FIG. 4, a sleeve 240 of the spindle motor according to the prior art has a straight shape in which the size from the inner diameter of the top end to the inner diameter of the bottom end of the sleeve about the axial direction is the same. Further, in the sleeve 240, the graph of the dynamic strength of the radial bearing part by an upper radial dynamic generation groove 242a and a lower radial dynamic generation groove 242b is shown like a P′ shape.

Being compared with FIG. 4, according to the preferred embodiment of the present invention, as shown in FIG. 3, the top and the bottom of the inner peripheral surface of the sleeve 140 is formed as a curved part R protruded toward the rotating shaft. Further, in the sleeve 140, the graph of the dynamic strength of the radial bearing part by the upper radial dynamic generation groove 142a and the lower radial dynamic generation groove 142b is shown like a P shape. Further, the P′ shown in a dotted line of FIG. 3 is a graph of the dynamic strength of the radial bearing part according to the prior art shown in FIG. 4.

By the above-mentioned configuration, it can be appreciated from the dynamic strength graph of the sleeve 140 according to the present invention that distance b between peak points is longer than distance a between peak points in the dynamic strength graph of the sleeve 240 according to the prior art and the dynamic strength is also reinforced by extending the span of the radial bearing part to the top end and the bottom end of the sleeve.

As a result, the spindle motor according to the preferred embodiment of the present invention improves the dynamic pumping capability and extends the span of the radial bearing part to the top end and the bottom end of the sleeve as compared with the spindle motor according to the prior art by manufacturing the sleeve as the sintered sleeve and changing the shape of the sleeve to form the top and the bottom of the inner peripheral surface of the sleeve as the curved part protruded toward the rotating shaft.

As set forth above, the preferred embodiment of the present invention can provide the spindle motor capable of improving dynamic pumping capability and extending the span of a radial bearing part to the top end and the bottom end of the sleeve as compared with the spindle motor according to the prior art by manufacturing the sleeve as the sintered sleeve and forming the top and the bottom of the inner peripheral surface of the sleeve as the curved part protruded toward the rotating shaft.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A spindle motor, comprising:
a rotating part including a rotating shaft, a hub, and a magnet; and
a fixing part including a sleeve supporting the rotating shaft and an armature opposite to the magnet,
wherein a working fluid is injected between the rotating shaft and the sleeve so as to form a fluid dynamic bearing part, and
the sleeve is formed as a sintered sleeve by sintering and a top and a bottom of an inner peripheral surface of the sleeve is protruded toward the rotating shaft.

2. The spindle motor as set forth in claim 1, wherein the top and the bottom of the inner peripheral surface of the sleeve are formed as a curved part protruded toward the rotating shaft.

3. The spindle motor as set forth in claim 1, wherein an inner diameter of the sleeve has the same size as a top end and a bottom end thereof about a direction of the rotating shaft and the size of the top end and the bottom end is smaller than that of a central portion thereof.

4. The spindle motor as set forth in claim 3, wherein the inner diameter of the central portion of the sleeve is larger by 0.1 to 1.0 μm than the inner diameter of the top end and the bottom end of the sleeve.

5. The spindle motor as set forth in claim 1, wherein the inner peripheral surface of the sleeve and an outer peripheral surface of the rotating shaft opposite thereto are selectively provided with radial dynamic generation grooves and a radial dynamic bearing part is formed by the radial dynamic generation grooves.

6. The spindle motor as set forth in claim 1, wherein the top of the sleeve opposite to the hub is provided with thrust dynamic generation grooves and a thrust bearing part is formed by the thrust dynamic generation grooves.

7. The spindle motor as set forth in claim 1, wherein the fixing part further includes:
a base having the sleeve fixed to an inner peripheral portion thereof by press-fit or an adhesive and having the armature fixed to an outer peripheral portion thereof so as to be opposite to the magnet by press-fit and an adhesive; and
a cover coupled with a bottom end of the base to support the rotating shaft and seal the fluid.
